(19) United States
(12) Patent Application Publication
(10) Pub. No.: US 2010/0044481 A1
(43) Pub. Date: Feb. 25, 2010

(54) Plastic autogenetic recycle machine (green machine)

(76) Inventor: Charles Eric Green, (US)

Correspondence Address: Charles Eric Green, 3909 Handley Ave, Louisville, KY, 40218, US

(21) Appl. No.: 12/229,539

(22) Filed: Aug. 25, 2008

(51) Int. Cl. B29B 17/00; B02C 25/00; B02C 19/00

(52) U.S. Cl. 241/33; 241/99; 241/100

(57) ABSTRACT

The present invention is directed toward a machine for recycling, compressing plastic waste for the purposes of minimizing space, maximizing manageability and other wise improving the logistics of recycling plastic bottles. The claimed invention is a powered machine that will receive, recycle, and containerize plastics bottles. The plastic autogenetic recycling machine would resemble a vending machine in size and would be placed in public locations for public use. The recycling machine will use technology to determine the size and weight of a bottle to ensure the bottle is empty. Such technology as multiple photo sensor eyes, ultrasonic sensors, liquid level sensors, automated digital identification (ADI) systems and voice powered technology is available to assist in the functionality of the plastic autogenetic recycling machine. The bottle will then go through a grinder, crushing or compressing system. The plastic material now takes up a minimum of space and is easily handled for recycling purposes, both in the recycle machine and at the recycling center. There will be computer monitored detections on the collection cylinders which will provide collection capacity and will not allow the machine to operate once it is full. The computer software that is available will allow the machine operational process and capacity levels to be monitored from a remote location.

### BACKGROUND OF THE INVENTION

1. Field of the Invention

The present invention is directed toward an apparatus for grinding, crushing and otherwise pulverizing plastic bottles, and more particularly directed to the public which gives the operator more control over when to recycle their plastic bottles.

2. Prior Art Statement

In recent years there has been a lot of focus given to recycling. The term going “green” is used more today in business then ever before. It represents the fact that businesses are recycling products. Plastic has become the material of choice for a majority of today's manufactured items. As a result, plastic makes up the largest percentage of solid waste in landfills. As many solid waste dumps across the country are approaching maximum capacity, and many municipalities have established recycling programs that include the recycling of plastic items. Unlike aluminum cans, plastic is not as easy to reduce its shape and condense its size. Most plastic beverages utilized by consumers are used away from any type of plastic recyclable bins. Consequently, when the plastic is discarded it retains most, if not all, of its original shape. The bulk of the material makes plastic hard to store and handle and does not lend itself to the logistics of recycling.

The present invention provides an automated machine that reduces the size and shape of plastic bottles in a public location. The present invention so orients the plastic that it is compressed into a dense form. The compacted plastic is now readily stored and easily recycled. This process makes the recycled material advantageous for a public recyclable machine and an existing or newly established supply chain logistics route for collection.

The problem of handling the bulk of used plastic bottles has been in existence for many years. Consequently, numerous devices have been invented and patented that crush, squeeze and shred plastic into more manageable forms. Prior art that is addressed directly to the combination of plastic for the purposes of recycling are exemplified by the following: However, these prior arts do not meet the need of the general public. These prior arts are designed for home and recycling centers use and not for public use. U.S. Pat. No. 4,703,899 to Lodovico, U.S. Pat. No. 3,951,059 to Morris, U.S. Pat. No. 3,504,621 to Qualheim and U.S. Pat. No. 4,923,126 to Lodovico et al, all show machines that use a series of shaping or cutting wheels to either flatten or pulverize plastic material. The end result of these prior art machines is either a flattened plastic product or plastic confetti. The flattened plastic products are only compressed in one plane and still demand a substantial space to be stored. These are designed for home recycling use.

U.S. Pat. No. 5,102,057 to Ellis III is an apparatus for compressing plastic waste by an apparatus that positions pointed teeth on tapered cylinders, the combination of teeth from a plurality of cylinders acting to simultaneously twist and compress a plastic product into a form more easily handled. However, this apparatus was originally designed for the home and recycling centers and not for the public use.

### SUMMARY OF THE INVENTION

The present invention is directed toward an apparatus for recycling plastic waste for the purposes of minimizing space, maximizing manageability and otherwise improving the logistics of a public recycling machine. The claimed invention is a powered machine that resembles a beverage vending machine. The machine will use modern technology to make it usable by the general public. The plastic will be received and eventually, passed through the bottom of the recycling process, wherein the plastic material is oriented in a compressed form. The plastic material now takes up a minimum of space and is easily handled for recycling purposes, both in the portable recycling machine and at the recycling or emitter facility.

### BRIEF DESCRIPTION OF THE DRAWINGS

The invention will be more fully understood by referring to the following detailed specifications, the above specification and the claims set forth herein, when taken in connection with the drawings appended hereto, wherein:

FIG. 1 shows a front perspective view of preferred embodiment of the present invention;

(a) Plastic bottle receiving portal

(b) Data display window

(c) Data key pad

(d) Upper plastic autogenetic recycling machine door

(e) Lower plastic autogenetic recycling machine door

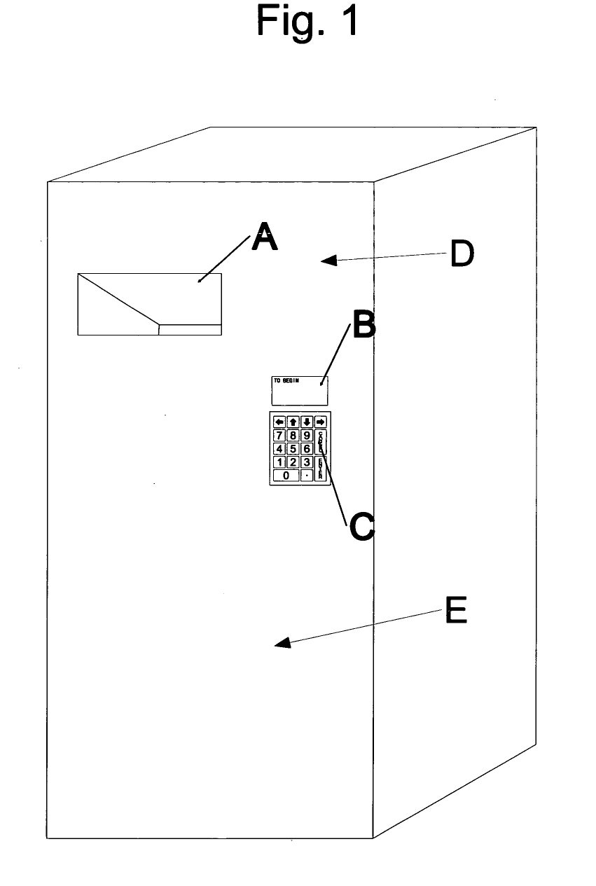

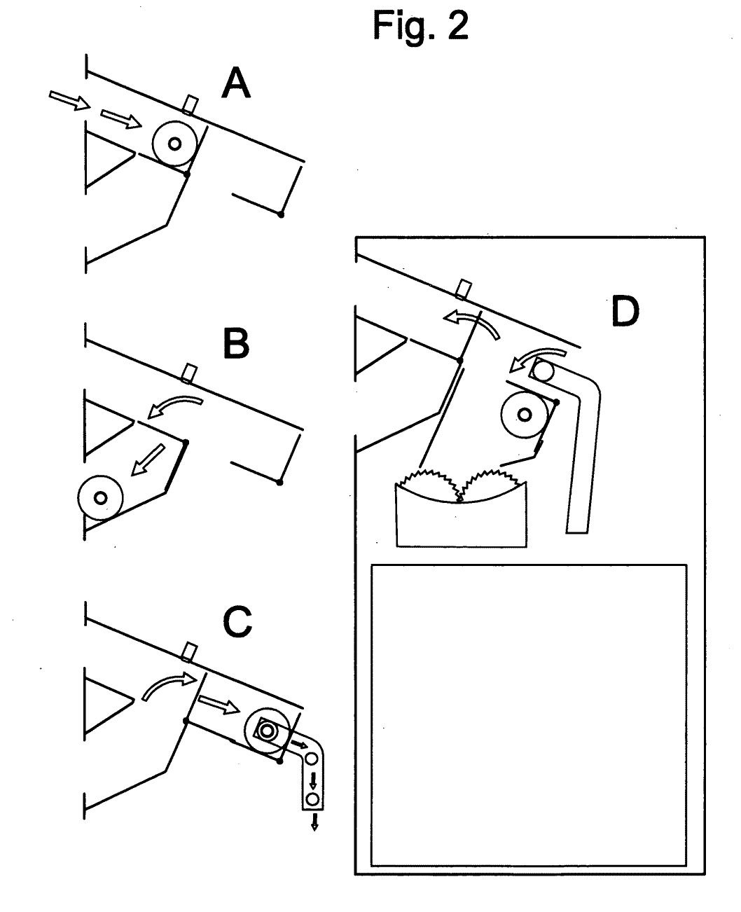

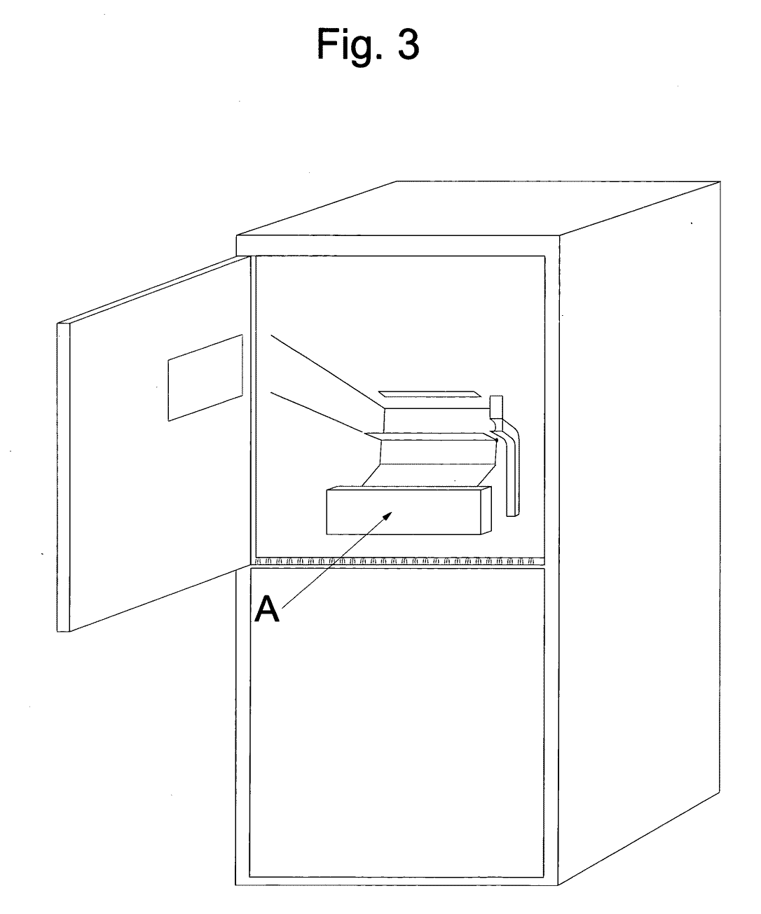

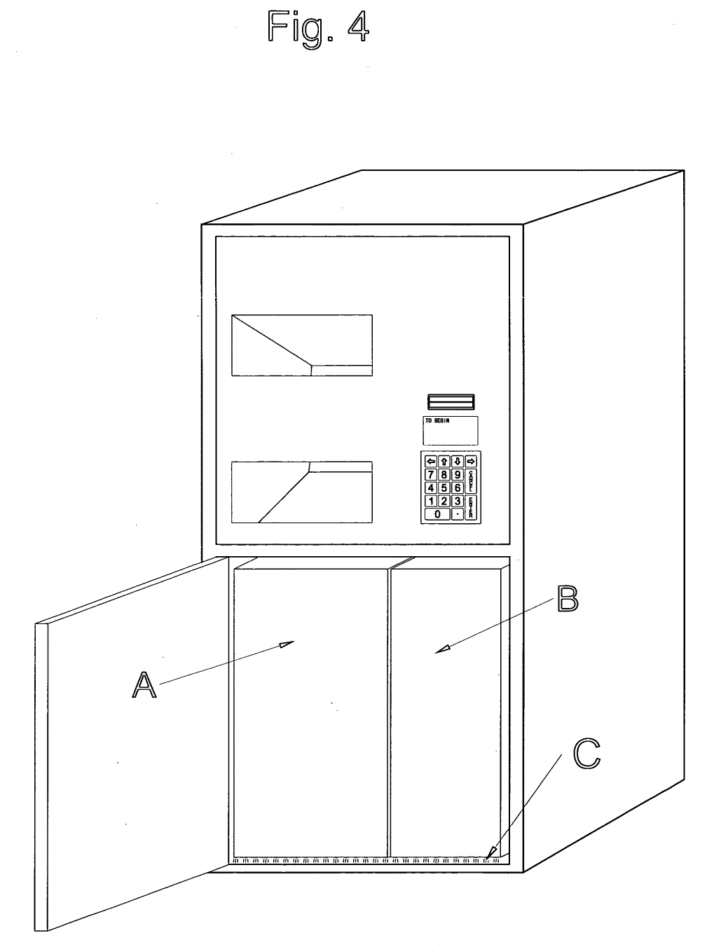

FIG. 2 shows a fragmented operational process of the embodiment shown in FIG. 1, having its upper door opened to best show the inner workings. This figure does not show all the details but is does show the elements of the claimed invention
(a) plastic bottles received into the autogenetic recycling machine
(b) plastic bottles rejected if not empty before received into the recycling process
(c) the option to remove the cap from the bottle
(d) the plastic bottle moves to the recycle process

FIG. 3 shows a fragmented prospective view to best illustrate the upper inner machine.
(a) recycle machine

FIG. 4 shows a fragmented prospective view to best illustrate the lower inner machine.
(a) collection bin for plastic bottles after the recycling process
(b) option for collection bin for plastic bottle top
(c) rollers to pull out the collection bins from the machine

### DESCRIPTION OF THE PREFERRED EMBODIMENT

The present invention is, as mentioned, directed toward an apparatus that compacts plastic bottle into a form, shape and density that allows the material to be easily stored and recycled. In today's society more and more individuals are being required to recycle their plastic wastes. Since plastic is usually used as a container, i.e. beverage bottles, plastic waste is highly bulky and has an extremely large size-to-weight ratio. When a retail establishment desire to recycle plastic, the recycle bin can quickly become filled with plastic. Since the collection of recyclable waste by local municipalities is not a daily event, many stores, retail establishments, and households must store the overflow of plastic waste in or around their establishments and homes. An obvious solution to the recycling of plastic waste is to compact the plastic before it is stored in a recycling bin. In the absence of some mechanical advantage, most people can only reduce the size of plastic products by one-third. With machines, plastic products can be reduced to under one-tenth of the original size. The invention described shows the best mode for a novel device that compact plastic products into a form that is both easily stored and handled in a public place.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Having thus described the invention, what is believed to be new and novel, and sought to be protected by Letters Patent of the U.S.

What is claimed as being new and desired to be protected by Letters Patent of the U.S. is as follows:

1. a public operated plastic recycling machine.
(a) The size and shape similar to that of a beverage vending machine.
(b) It could have the option to provide a refund for recycled product
(c) Receives, recycle and collect plastic bottles.
(d) Placed in public locations for public use.
(e) The machine will receive empty plastic bottles.
(f) A means to determine if the bottle is empty before it is received and process.
(g) If the bottle is not empty it would be rejected and not allowed to enter the machine.
(h) A means to remove the bottle cap if necessary before recycling the bottle.

2. The apparatus of claim 1 wherein said recycle machine will have the appearance of a vending machine in its size and shape which is used for recycling of empty plastic beverage bottled.

3. The apparatus of claim 1 wherein said recycle machine will have a recycle process (grinder, crushing or compressing system) whereby to increase the number of bottles that the machine can receive.

4. The apparatus of claim 1 wherein said machine will use modern technology to help assist in the functionality and operation making it user friendly to the public. Some available technology that is available is: multiple photo sensor eyes, ultrasonic sensors, liquid level sensors, automated digital identification (ADI) systems and voice recorded instructions.

5. The apparatus of claim 1 wherein the rotation of said collections containers for the recycled plastic will be monitored by visual and automated capability.

6. The apparatus of claim 1 wherein a removable collection container is positioned below said outlet at the bottom of said machine to collect compacted plastic for retrieval.
